(19) United States
(12) Patent Application Publication
(10) Pub. No.: US 2022/0062935 A1
(43) Pub. Date: Mar. 3, 2022

(54) SPRAY NOZZLE WITH INTEGRATED FLOW FEEDBACK AND CONTROL

(71) Applicant: Unist, Inc., Grand Rapids, MI (US)

(72) Inventors: Timothy J. Bangma, Lowell, MI (US); Zachary E. Talen, Grand Rapids, MI (US)

(21) Appl. No.: 17/408,617

(22) Filed: Aug. 23, 2021

Related U.S. Application Data
(60) Provisional application No. 63/070,454, filed on Aug. 26, 2020.

(51) Int. Cl. B05B 12/00; B05B 7/12

(52) U.S. Cl. CPC B05B 12/008; B05B 7/12

(57) ABSTRACT

A liquid delivery system including a spray nozzle that includes a spray tip. The spray nozzle receives liquid via a liquid supply line. The spray tip of the spray nozzle generates an atomized liquid spray output when the liquid flowing through the spray nozzle passes through the spray tip. The spray nozzle includes a fluid control valve and a flow meter. The fluid control valve controls a flow rate of the liquid dispensed by the spray nozzle. The flow meter determines a flow rate of the liquid dispensed by the spray nozzle. The spray nozzle also includes a housing configured to retain and support the fluid control valve and the flow meter. The liquid delivery system includes a controller that provides feedback and control of the spray nozzle by receiving a flow rate signal from the flow meter and outputting a control signal to the fluid control valve.

### CROSS REFERENCE TO RELATED APPLICATION

The present application claims the benefit of U.S. provisional application Ser. No. 63/070,454, filed Aug. 26, 2020, which is hereby incorporated herein by reference in its entirety.

### FIELD OF THE INVENTION

The present invention is directed to liquid delivery systems, such as liquid delivery systems that deliver a metered layer of liquid onto a substrate.

### BACKGROUND OF THE INVENTION

Industrial processes often require the spraying of various liquid (or fluid-type) materials onto substrates in a uniform and controlled manner. Examples of such applications include coating metal with lubricant before cutting or forming processes, coating metal with a rust preventative for long term storage, or coating wires with hydrated dry film lubricant useful for downstream processing. In each of these cases, there is an optimal thickness of the layer of the liquid to be deposited on the substrate. To achieve a consistent layer thickness of the liquid, the ratio of the substrate speed to the rate of material deposition by the nozzle must be maintained in order to provide a consistent coating. Insufficient coating can lead to process errors and over-coating is wasteful.

### SUMMARY OF THE INVENTION

Embodiments of the present invention provide for a liquid delivery system configured to produce an atomized fluid spray at a selected flow rate. The liquid delivery system includes a spray nozzle with integrated liquid flow feedback and control. The liquid delivery system also includes a fluid control valve, a flow sensor, and a controller. The controller provides the feedback and control by receiving a flow-rate signal from the flow meter and controlling the output of the spray nozzle by transmitting a control signal to the fluid control valve.

A liquid delivery system in accordance with the present invention includes a spray nozzle with an integrated liquid flow feedback and control. The spray nozzle includes a nozzle configured to generate an atomized liquid spray when liquid passes through the nozzle. The spray nozzle includes a nozzle housing configured to retain and support the nozzle as well as retain and support a fluid control valve and a flow meter. The fluid control valve is configured to control a flow rate of the liquid dispensed by the spray nozzle assembly. The flow meter is configured to determine a flow rate of the liquid dispensed by the spray nozzle assembly.

In an aspect of the present invention, the liquid delivery system includes a controller configured to provide feedback and control of the spray nozzle by receiving a flow-rate signal from the flow meter and subsequently outputting a control signal to the fluid control valve to control the output of the spray nozzle. The feedback and control of the controller may be defined by parameters, such as, a desired speed, a spray pattern width, and a film application thickness. These parameters may also be input via operator input. Such inputs may include a selected quantity of fluid to apply to a substrate. Examples include any of a selected volume of coating per area, a selected mass of coating per area, and/or a selected film thickness of coating.

In a further aspect of the present invention, the spray nozzle may be configured to provide either a liquid-only atomized liquid spray or an air atomized liquid spray. When the spray nozzle is configured to provide an air atomized liquid spray, the spray nozzle is configured to also receive compressed air from a pressurized source and mix a compressed air flow with the liquid flow to generate the air atomized liquid spray pattern.

In another aspect of the present invention, the flow of compressed air in the spray nozzle assembly is controlled via an air control valve retained and supported by the nozzle housing.

In yet a further aspect of the present invention, the air control valve is a pneumatic solenoid valve configured to provide an ON/OFF control of the supply of the compressed air. Alternatively, the air control valve is a proportional pneumatic solenoid valve configured to provide both an ON/OFF control of the supply of compressed air as well as a throttling of the supply of pressurized air in the spray nozzle.

Another liquid delivery system in accordance with the present invention includes a first spray nozzle that includes a spray tip. The first spray nozzle is configured to receive liquid via a liquid supply line. The spray tip of the first spray nozzle is configured to generate an atomized liquid spray output when the liquid passes through the spray tip. The first spray nozzle includes a fluid control valve and a flow meter. The fluid control valve is configured to control a flow rate of the liquid dispensed by the first spray nozzle. The flow meter is configured to determine a flow rate of the liquid dispensed by the first spray nozzle. The first spray nozzle also includes a housing configured to retain and support the spray tip, the fluid control valve, and the flow meter.

Still another liquid delivery system in accordance with the present invention includes a plurality of spray nozzles arranged with respect to each other to form an arrangement of spray nozzles. Each of the plurality of spray nozzles comprises a respective spray tip. Each of the plurality of spray nozzles is configured to receive liquid via a common liquid supply line. Each of the spray tips is configured to generate an atomized spray output when the liquid flowing through the respective spray nozzles exits through their respective spray tips. Each of the plurality of spray nozzles further includes a respective fluid control valve and flow meter. Each fluid control valve is configured to control a flow rate of the liquid dispensed by the respective spray nozzle. Each flow meter is configured to determine a flow rate of the liquid dispensed by the respective spray nozzle. Each of the plurality of spray nozzles also includes a respective housing configured to retain and support the respective spray tips, the fluid control valves, and the flow meters of the respective spray nozzles.

In an aspect of the present invention, the liquid delivery system includes a controller configured to provide feedback and control of the plurality of spray nozzles by receiving flow-rate signals from each of the respective flow meters and subsequently outputting control signals to each of the respective fluid control valves to control the output of the plurality of spray nozzles. The feedback and control provided by the controller may be defined by parameters, such as, a desired speed, a spray pattern width, and a film application thickness. These parameters may be input via operator input and/or derived. Such inputs may include a selected volume of coating per area, a selected mass of coating per area, and/or a selected film thickness of coating.

In a further aspect of the present invention, the flow meter is configured to determine either a volumetric flow rate or a mass flow rate of the liquid dispensed by the spray nozzle.

These and other objects, advantages, purposes and features of the present invention will become apparent upon review of the following specification in conjunction with the drawings.

### BRIEF DESCRIPTION OF THE DRAWINGS

FIG. 1 is a block diagram of an exemplary liquid-only atomized spray nozzle in accordance with an embodiment of the present invention;

FIG. 2 is a block diagram of an exemplary arrangement of a plurality of the spray nozzles of FIG. 1 according to an embodiment of the present invention;

FIG. 3 is a block diagram of an exemplary air atomized spray nozzle in accordance with an embodiment of the present invention;

FIG. 4 is a block diagram of an alternative air atomized spray nozzle with a pneumatic solenoid valve for controlling the flow of air within the spray nozzle in accordance with an embodiment of the present invention;

FIG. 5 is block diagram of an exemplary arrangement of a plurality of the spray nozzles of FIG. 4 in accordance with an embodiment of the present invention;

FIG. 6 is a block diagram of another alternative air atomized spray nozzle with an air control valve for proportionally controlling the flow of air within the spray nozzle in accordance with an embodiment of the present invention;

FIG. 7 is a block diagram of a liquid delivery system in accordance with an embodiment of the present invention;

FIG. 8 is a perspective view of an exemplary air atomized spray nozzle in accordance with an embodiment of the present invention;

FIG. 9 is another perspective view of the air atomized spray nozzle of FIG. 8 in accordance with an embodiment of the present invention; and

FIG. 10 is a perspective view of an arrangement of a plurality of the spray nozzles of FIG. 8 in accordance with an embodiment of the present invention.

### DETAILED DESCRIPTION OF THE PREFERRED EMBODIMENTS

Referring now to the drawings and the illustrative embodiments depicted therein, a liquid delivery system for delivering an atomized liquid spray at a selected flow rate is provided for applying a liquid onto a substrate in a uniform and controlled manner. The liquid delivery system includes a spray nozzle with an integrated flow feedback and control. The spray nozzle includes a nozzle for generating the atomized liquid spray when the liquid flows through the nozzle. The spray nozzle includes a fluid control valve for controlling a flow rate of the liquid dispensed by the liquid delivery system. The spray nozzle also includes a flow meter for determining a volumetric flow rate of the liquid flowing through the spray nozzle. Alternatively, the flow meter determines a mass flow rate of the liquid flowing through the spray nozzle. The liquid delivery system also includes a controller that provides feedback and control of the spray nozzle by receiving a flow-rate signal from the flow meter and subsequently outputting a control signal to the fluid control valve to control the output of the spray nozzles. The spray nozzle may be configured to provide either a liquid-only atomized liquid spray or an air atomized liquid spray. When configured to provide an air atomized liquid spray, the spray nozzle may optionally include an air control valve for controlling the flow of pressurized air passing through the spray nozzle. Similar to the fluid control valve, the air control valve receives a control signal from the controller.

When a liquid delivery system is applying a liquid coating, there is often an optimal thickness of the layer of liquid to be deposited on a substrate, metal, or wires (hereinafter, referred to as a “substrate”). The substrate often travels with respect to the spray nozzle that applies the liquid coating. To achieve a consistent layer thickness of the liquid, the ratio of the substrate speed to the rate of liquid deposition by the spray nozzle should be maintained in order to provide a consistent coating. Insufficient coating can lead to process errors. Alternatively, the spray nozzles may be moved over the substrate at a fixed velocity, such that the liquid flow rate can be constant. However, often the substrate's velocity relative to the spray nozzle is variable and, therefore, the flow rate through the spray nozzle must change as the velocity of the substrate changes.

There are several factors that affect the flow rate of the liquid from the spray nozzle when the spray nozzle is open and allowing the liquid to pass through to be dispensed as a spray upon the substrate. These factors include fluid pressure, fluid viscosity, contamination or debris build-up in the spray nozzle, and temperature. Some of these factors are controllable, while other factors are independent and need to be dealt with. Also, in many industrial processes multiple spray nozzles might need to be used to coat the entire surface of the substrate. Multiple spray nozzles may be configured as a spray manifold (an arrangement of spray nozzles that receives liquid and air from a common source). Some of the factors affecting the flow rate are universal, in that they affect all of the spray nozzles of a spray manifold, but other factors are individual in nature. For example, fluid supply temperature, pressure, and fluid viscosity will have an effect on all of the spray nozzles in a spray manifold, however, buildup of debris in a particular spray nozzle affects only that particular spray nozzle of the spray manifold. The ability to then monitor and control the liquid flow rate of each nozzle independently of the others is therefore useful.

Several control methods exist for metering the flow of fluid through the spray nozzle. One method includes globally monitoring the performance of the entire spray manifold by watching spray manifold-wide variations in pressure or flow rate of the fluid passing through the spray nozzles. However, this method lacks the precision to indicate issues or to make adjustments to just one of the individual spray nozzles of the spray manifold.

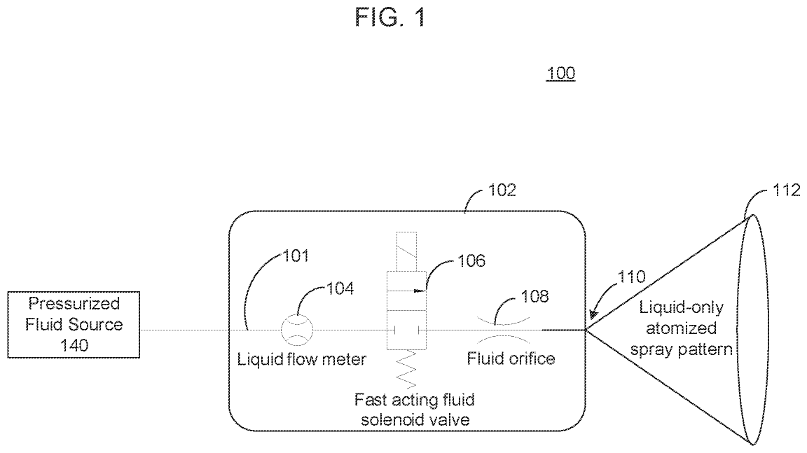

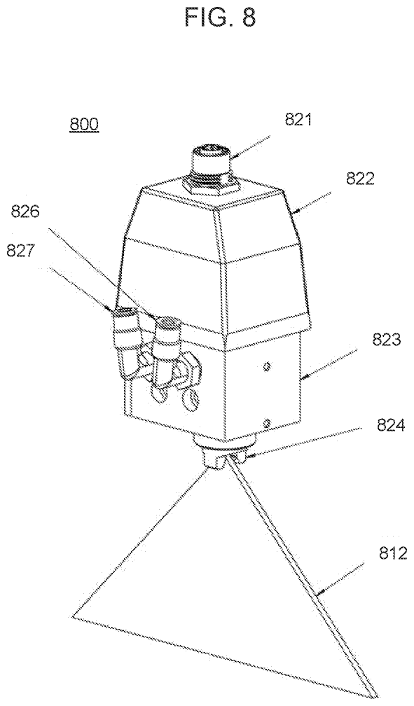

Referring now to FIG. 1, an exemplary spray nozzle assembly 100 is configured for delivering a liquid-only atomized spray pattern 112. The spray nozzle assembly 100 receives fluid (e.g., lubrication, corrosion preventative solutions, hydrated dry film lubricants, and other similar liquids) from a pressurized fluid source 140. The pressurized fluid source 140 outputs fluid at a selected pressure. The pressurized fluid source 140 may include a pump for outputting the fluid at the selected pressure. The pressurized fluid flows through a liquid flow meter 104 where a flow rate is determined. The pressurized fluid then flows to a fluid control valve 106 that is used to meter the flow of fluid through the spray nozzle 100 to achieve a desired flow rate. Optionally, after the fluid control valve 106, the pressurized fluid is further restricted by a fixed, small orifice 108. As a fluid-only atomizing spray nozzle, the atomized spray pattern 112 is developed just by the flow of the fluid through a spray tip 110 of the spray nozzle assembly 100. As illustrated in FIGS. 8-10, the components of the spray nozzle assembly 100 of FIG. 1 are enclosed within a nozzle housing 102. The nozzle housing 102 retains and supports the liquid flow meter 104, the fluid control valve 106, the optional fluid orifice 108, and the spray tip 110, such that they are enclosed within the nozzle housing 102 (see FIGS. 8-10).

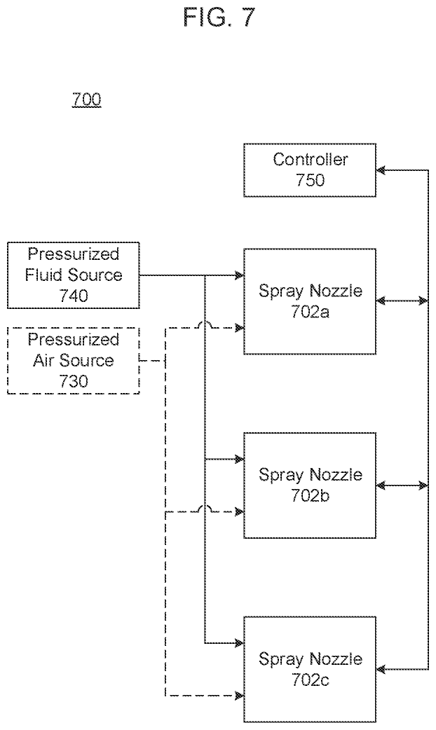

Embodiments of the spray nozzle assembly 100 provide a means for controlling the flow rate of the fluid as well as a means for measuring the volumetric flow rate from the spray nozzle assembly 100 for feedback to a controller 750 for on-the-fly adjustments of operating parameters as required (see FIG. 7). Alternatively, a means for measuring a mass flow rate from the spray nozzle assembly 100 is provided. As a liquid-only spray nozzle, the spray nozzle assembly 100 relies on the velocity of the fluid passing through the small orifice 108 and the spray tip 110 to pulverize the fluid and create the atomized spray pattern 112.

The fluid control valve 106 may be implemented as a fast-acting fluid solenoid valve. While the exemplary solenoid valve opens and closes at an adjustable rate (e.g., 30 Hz), a duty cycle (i.e., the ratio between action ON time and OFF time) of the solenoid valve is varied to adjust the apparent flow rate of the fluid through/from the spray nozzle 100. The fast operation (e.g., 30 Hz) makes the flow rate coming out of the spray nozzle appear to be continuous even though it is pulsed. Alternatively, the fluid control valve 106 can be implemented as a proportional needle valve that is electronically actuated by either a proportional solenoid coil or some type of rotary or linear actuator to increase and decrease the orifice size, which would increase and decrease the fluid flow. Another embodiment would provide a variable fluid pressure source to the spray nozzle assembly 100 and the flow rate out of the spray nozzle assembly 100 would be adjusted by adjusting the fluid pressure.

The liquid flow meter 104 may be implemented as a digital flow meter. An exemplary digital flow meter is a thermal flow meter that is integrated into a nozzle fluid flow channel 101 (see FIG. 1) just upstream of the fluid control valve 106. An exemplary thermal flow meter comprises (in the direction of liquid flow) a temperature sensor, a heating element, and a second temperature sensor. A difference in temperatures recorded by the two temperature sensors is inversely proportional to the fluid flow rate, such that the fluid flow rate can be deduced. The resulting flow rate information is reported back to the controller 750 (see FIG. 7). Other exemplary flow sensor technologies may be used for measuring fluid flow to a spray tip 110 (e.g., ultrasonic, thermal wire, inductive, and mechanical paddle).

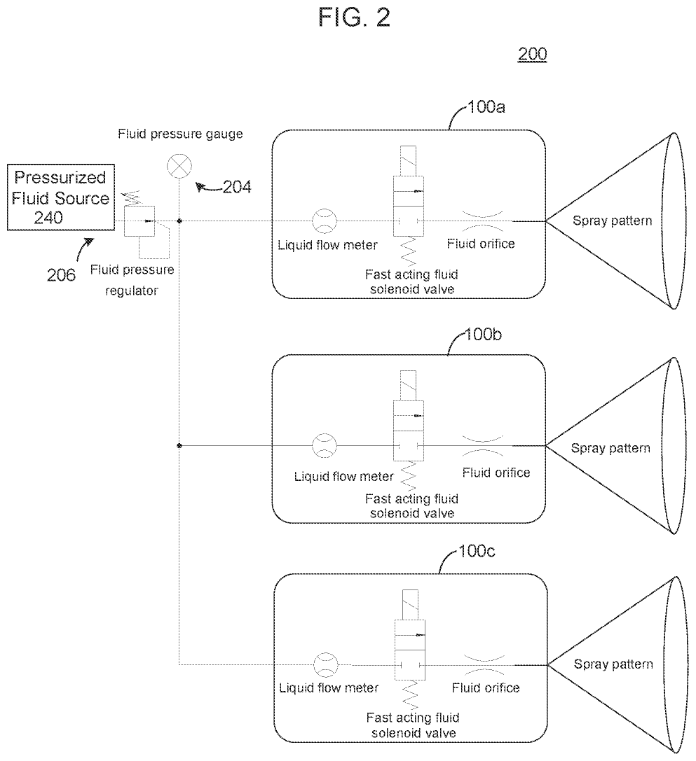

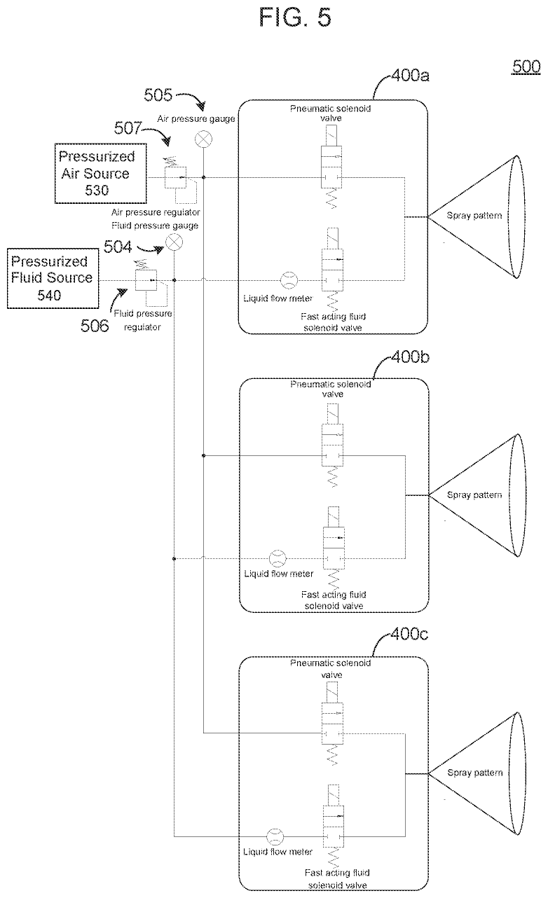

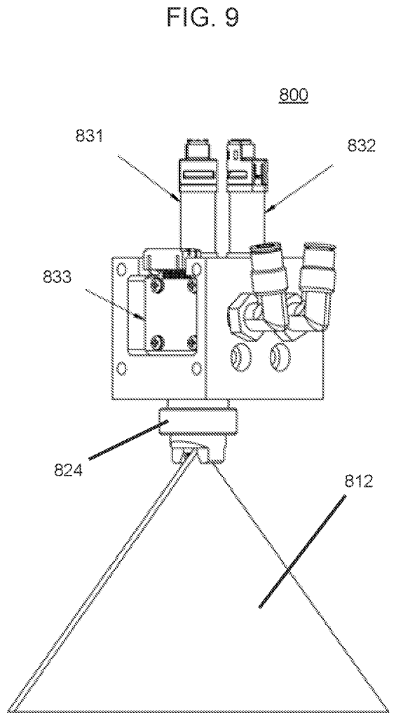

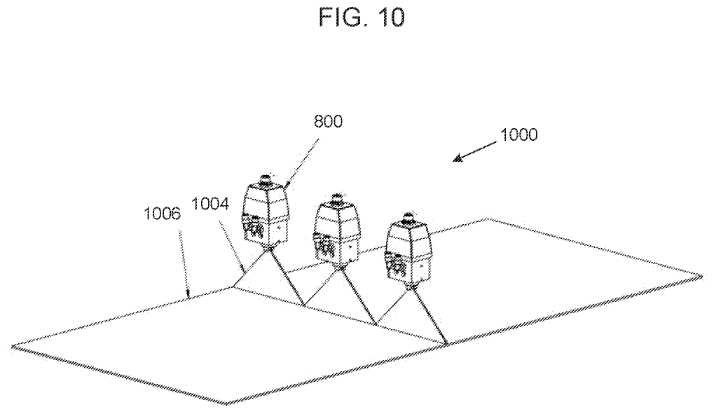

As illustrated in FIGS. 2, 7 and 10, multiple spray nozzle assemblies may be arranged together to form a nozzle manifold 200, 700, 1000 to provide a desired spray coverage 1004 over a substrate 1006 (see FIG. 10). Feedback and control of the nozzle manifold 200, 700, 1000 (as well as individual spray nozzles) is provided by a controller, such as the controller 750 of FIG. 7. As illustrated in FIGS. 9 and 10, the desired spray coverage 1004 is formed by the respective spray patterns 812 of the respective spray nozzle assemblies 800. As illustrated in FIG. 7, an arrangement of spray nozzles 702a-c that form a nozzle manifold 700 are supplied with fluid from a common pressurized fluid source 740, as well as optionally supplied with compressed air from a common pressurized air source 730 (similar to the common pressurized air source 530 of FIG. 5). The spray nozzles 702a-c are individually controlled by the controller 750. As illustrated in FIG. 2, each spray nozzle 100a-c of a spray nozzle manifold 200 is supplied with fluid from a common pressurized fluid source 240 that is controlled by a system fluid pressure regulator 206 and monitored by a fluid pressure gauge 204. The controller 750 monitors and controls the fluid (and optionally the compressed air) supplied to each spray nozzle. The controller 750 is also configured to monitor the fluid flow rate data provided by integral flow meters from each spray nozzle (see FIGS. 1 and 2 for arrangements of integral flow meters 104 in spray nozzles 100a-c), and to make adjustments to the operating parameters of the spray nozzles to dispense the correct amount of fluid to the substrate as it travels by the spray nozzles of the nozzle manifold. The controller 750 of FIG. 7 adjusts the valve duty cycle and fluid pressure to individually control the flow rate out of the spray nozzles 702a-c (via a fluid control valve (see FIGS. 1 and 2)). The speed of the substrate passing under the spray nozzle could also be monitored and the flow rate (e.g. volumetric flow rate and mass flow rate) of the spray nozzle adjusted to compensate.

The controller, such as the controller 750 of FIG. 7, is also configured to measure the speed of a substrate 1006 (see FIG. 10) with respect to a spray nozzle to calculate the speed at which the substrate 1006 is moving. Alternatively, the controller 750 is configured to receive parameter information from an external device. In a further alternative, the controller 750 receives parameter information through operator input via an input device communicatively coupled to the controller 750. The controller 750 also receives an input (via an input device) from an operator that indicates the amount of fluid to be applied to the substrate 1006. The “amount” of fluid can be indicated as a volume of coating per area, a mass of coating per area, and/or a film thickness for the coating (for a given area). Thus, the controller 750 is also configured to receive an input from an operator (via an input device) about a desired width of the spray pattern. The controller 750 is operable to use a measured or given speed, a spray pattern width, and a film thickness to determine an appropriate flow rate from the spray nozzle. Thus, the controller 750 of FIG. 7 controls a spray nozzle, such as the spray nozzle 110 of the spray nozzle assembly 100 of FIG. 1, using, for example, a flow rate signal from the liquid flow meter 104 and outputs a control signal to the fluid control valve 106.

The individual spray nozzles 100a-c of the nozzle manifold 200 (FIG. 2) are provided pressurized fluid from a single common fluid source 240, the pressure of the fluid flowing to the spray nozzles 100a-c can be adjusted to maintain a desired flow with the fluid pressure regulator 206 and monitored with the fluid pressure gauge 204, such as shown in FIG. 2. As discussed herein, feedback and control via the fluid pressure gauge 204 and the fluid pressure regulator 206 are provided by a controller, such as the controller 750 of FIG. 7. Adjusting the fluid pressure at the fluid pressure regulator 206 can globally influence the flow rate for each spray nozzle 100a-c in the spray manifold 200. However, the corresponding fluid control valve 106 and flow meter 104 combination in each spray nozzle assembly 100 allows for individual and independent control of the liquid flow rate from each spray nozzle 100a-c (see FIGS. 1 and 2). Note that the feedback and control of the spray nozzle assemblies 100 is provided by a controller, such as the controller 750 of FIG. 7, which receives a flow rate signal from the fluid pressure gauge 204 and outputs a control signal to the fluid pressure regulator 206. Thus, the fluid pressure regulator 206 and fluid pressure gauge 204 may be used to monitor and maintain a desired fluid flow status to the individual spray nozzles 100a-c, respectively.

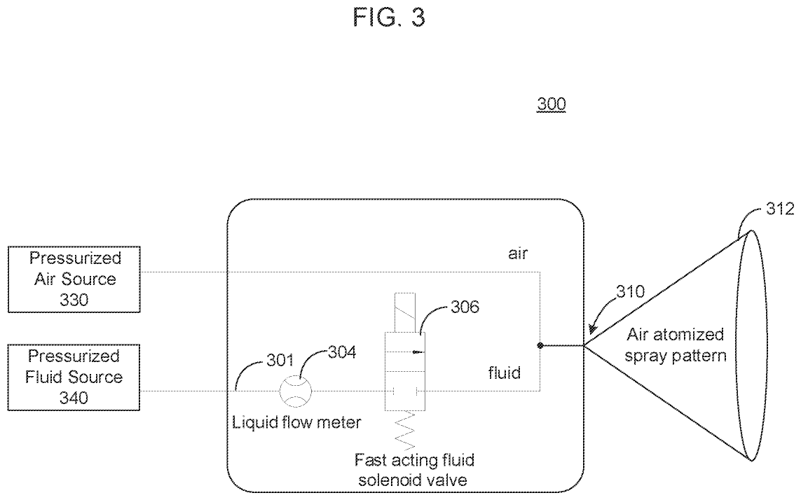

FIG. 3 illustrates an exemplary spray nozzle assembly 300 configured for delivering an air atomized spray pattern 312. The fluid supply, monitoring, and control is the same as illustrated in FIG. 1, in that spray nozzle assembly 300 of FIG. 3 receives fluid from a pressurized fluid source 340. That pressurized fluid flows through a liquid flow meter 304 where a flow rate is determined. The pressurized fluid then flows to a fluid control valve 306 that is used to meter the flow of fluid through the spray nozzle 300. As illustrated in FIG. 3, the spray nozzle assembly 300 includes a pressurized air source 330 which outputs air at a selected pressure level. The pressurized air source 330 may include a pump for outputting the air at the selected pressure level. Other means for pressurizing the air may also be used (e.g., a pressurized air tank with a sufficient quantity of pressurized air may be used). With the pressurized air source 330 supplying compressed air to the spray nozzle assembly 300, the air atomized spray pattern 312 is generated by introducing the compressed air to the nozzle fluid flow channel 301, where the combined fluid/air mix are expelled from the spray nozzle 310 in the air atomized spray pattern 312. An air supply control (ON/OFF) and air flow rate throttling are performed externally of the spray nozzle 300. Similar to the spray nozzle assemblies 100 of FIGS. 1 and 2, the spray nozzle assembly 300 is controlled by a controller, such as the controller 750 of FIG. 7. Thus, the controller provides feedback and control of the spray nozzle assembly 300 by receiving a flow rate signal from the liquid flow meter 304 and outputting a control signal to the fluid control valve 306.

Like the spray nozzles 100 of FIG. 1, multiple spray nozzles 300 of FIG. 3 may be arranged to form a nozzle manifold to provide a desired coverage over a substrate (see FIG. 10). Thus, the spray nozzles 702a-c of FIG. 7 can be implemented as embodiments of the spray nozzle 300 of FIG. 3, with each spray nozzle 702a-c receiving pressurized fluid and pressurized air from a single fluid source and a single air source, respectively. Furthermore, the spray nozzles 702a-c of FIG. 7, when implemented as embodiments of the spray nozzle 300 of FIG. 3 to form a nozzle manifold, the controller 750 is operable to provide feedback and control of the nozzle manifold by receiving flow rate signals from each of the respective flow meters 304 and outputting control signals to each of the respective fluid control valves 306.

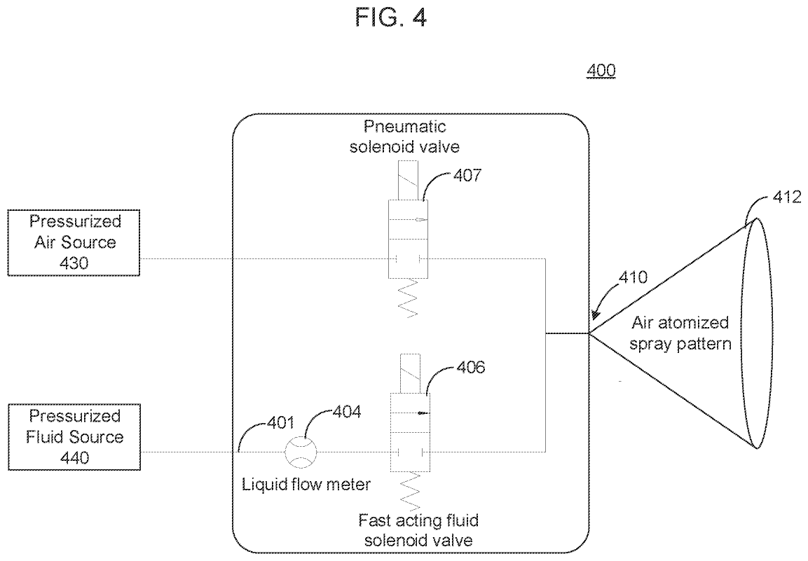

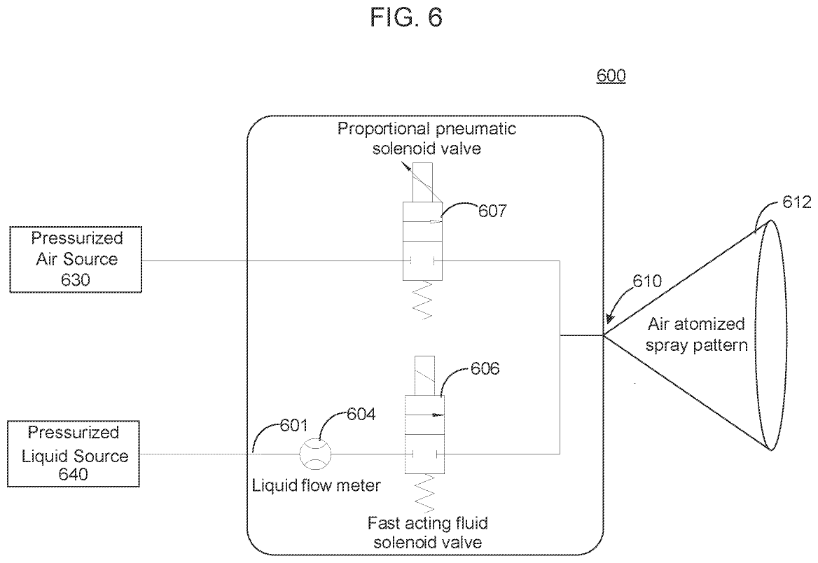

FIGS. 4 and 6 illustrate exemplary spray nozzle assemblies 400, 600 configured for delivering an air atomized spray pattern 412, 612. Like the spray nozzle assembly 300 of FIG. 3, the fluid supply, monitoring, and control is the same as illustrated in FIG. 1, in that the spray nozzle assemblies 400, 600 of FIGS. 4 and 6 receive fluid from pressurized fluid sources 440, 640. That pressurized fluid flows through a liquid flow meter 404, 604 where a respective flow rate is determined. The pressurized fluid then flows to a fluid control valve 406, 606 that is used to meter the flow of fluid through the respective spray nozzle 400, 600. While the spray nozzle assembly 300 of FIG. 3 is supplied with compressed air that is introduced to the nozzle fluid flow channel 301 without any sort of control valve, the spray nozzle assemblies 400, 600 of FIGS. 4 and 6 include respective control valves 407, 607 for controlling the flow of compressed air to their respective nozzle fluid flow channels 401, 601. The control valve 407 of FIG. 4 provides an ON/OFF control of the supply of compressed air flowing through the spray nozzle assembly 400. The control valve 407 is an exemplary pneumatic solenoid valve. The control valve 607 of FIG. 6 provides a proportional control of the flow of compressed air flowing through the spray nozzle assembly 600. The control valve 607 is an exemplary proportional pneumatic solenoid valve Like with the spray nozzle assembly 300, respective air atomized spray patterns 412, 612, illustrated in FIGS. 4 and 6, are generated by introducing the compressed air to the nozzle fluid flow channels 401, 601, where the combined fluid/air mix is expelled from the spray nozzles 410, 610 in the air atomized spray patterns 412, 612.

Like the spray nozzles 100, 300 of FIGS. 1 and 3, multiple spray nozzles 400, 600 of FIGS. 4 and 6 can be arranged to form a nozzle manifold 500 as illustrated in FIG. 5. While the nozzle manifold 500 of FIG. 5 illustrates a plurality of spray nozzle assemblies 400 of FIG. 4, the spray nozzle assemblies 400 can be replaced with the spray nozzle assemblies 600 of FIG. 6. Thus, multiple spray nozzles 400, 600 can be arranged to form a nozzle manifold 500 to provide a desired coverage over a substrate (see FIG. 10). The spray nozzles 702a-c of FIG. 7 can also be implemented as embodiments of the spray nozzles 400, 600 of FIGS. 4 and 6, with each spray nozzle 702a-c receiving fluid and compressed air from a single common pressurized fluid source 440, 640 and a single common pressurized air source 430, 630, respectively. The pressurized air sources 430, 630 are similar to the pressurized air source 330 discussed herein. The common pressurized fluid source 540 is controlled with a system fluid pressure regulator 506 and monitored with a system fluid pressure gauge 504, while the single common pressurized air source 530 is controlled by a system air pressure regulator 507 and monitored with a system air pressure gauge 505 (see FIG. 5). Outputs of the system fluid pressure gauge 504 and the system air pressure gauge 505 are monitored by a controller (e.g., the controller 750 of FIG. 7), such that the controller is able to output control signals to the system fluid pressure regulator 506 and the system air pressure regulator 505 to maintain a desired fluid/air pressure to the spray nozzles.

FIGS. 8-10 illustrate perspective views of an exemplary spray nozzle 800 which includes a top cover or housing 822 with an electrical connection 821 positioned atop the top housing 822 for communicatively coupling the spray nozzle 800 to a lubrication system controller (e.g., controller 750 of FIG. 7). A nozzle block 823 is positioned beneath the top housing 822. As illustrated in FIGS. 8 and 9, while an air inlet connection 826 and a fluid inlet connection 827 are positioned on a side of the nozzle block 823 for receiving compressed air and fluid, respectively, the top housing 822 covers a fluid control valve 831 and an air control valve 832. FIG. 9 illustrates the spray nozzle 800 of FIG. 8 with at least the top housing 822 removed to view the interior of the spray nozzle 800. On a side of the nozzle block 823 adjacent the air inlet connection 826 and the fluid inlet connection 827, a fluid flow meter 833 monitors the flow of fluid, which is combined with the compressed air and expelled through a spray tip 824 to create an air atomized spray pattern 812.

FIG. 10 illustrates a network of spray nozzles 800 arranged as a nozzle manifold 1000. The arrangement of spray nozzles 800 provides for a spray pattern 1004 that covers a substrate 1006 moving beneath the spray manifold 1000. FIG. 10 also illustrates an exemplary arrangement of spray nozzles 800. In this example, the spray nozzles 800 are arranged into a linear array. Other arrangements are possible depending on the coverage needs of the system (e.g., a grid arrangement of spray nozzles 800).

Thus, the liquid delivery systems of the present invention provide an atomized liquid spray pattern that is continuously optimized for a given application and is responsive to changing conditions. The exemplary liquid delivery system includes a spray nozzle with an integrated flow feedback and control. The spray nozzle includes a fluid control valve for controlling a flow rate of the liquid dispensed by the liquid delivery system, as well as a flow meter for determining a flow rate (e.g., volumetric flow rate and mass flow rate) of the liquid dispensed by the liquid delivery system. Lastly, the exemplary spray nozzle may optionally include an air control valve for controlling the flow of pressurized air supplied to the spray nozzle. The exemplary spray nozzle may provide either a liquid-only atomized liquid spray or an air atomized liquid spray. Thus, the exemplary liquid delivery system provides an atomized liquid spray pattern at a selected flow rate for applying liquid onto a substrate in a uniform and controlled manner.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. Therefore, it will be appreciated that changes and modifications in the specifically described embodiments can be carried out without departing from the principles of the present invention which is intended to be limited only by the scope of the appended claims, as interpreted according to the principles of patent law including the doctrine of equivalents.

1. A liquid delivery system comprising:
a first spray nozzle comprising a spray tip, wherein the first spray nozzle is configured to receive liquid via a liquid supply line, and wherein the spray tip of the first spray nozzle is configured to generate an atomized liquid spray output when the liquid flowing through the first spray nozzle exits through the spray tip; and
wherein the first spray nozzle comprises:
a fluid control valve and a flow meter, wherein the fluid control valve is configured to control a flow rate of the liquid dispensed by the first spray nozzle, and wherein the flow meter is configured to determine a flow rate of the liquid dispensed by the first spray nozzle; and
a housing configured to retain and support the fluid control valve and the flow meter.

2. The liquid delivery system of claim 1, wherein the first spray nozzle is configured to receive air via an air supply line, and wherein the spray tip of the first spray nozzle assembly is configured to generate an air atomized liquid spray output when combined liquid and air pass through the spray tip.

3. The liquid delivery system of claim 2, wherein the air is compressed air received from a pressurized air supply source comprising a pressure tank or an air compressor.

4. The liquid delivery system of claim 2, wherein the first spray nozzle further comprises an air control valve configured to control the flow of air in the first spray nozzle assembly, and wherein the housing is configured to retain and support the air control valve.

5. The liquid delivery system of claim 4, wherein the air control valve is configured to turn the flow of air on and off.

6. The liquid delivery system of claim 4, wherein the air control valve is configured to vary the flow rate of air.

7. The liquid delivery system of claim 1 further comprising a controller configured to monitor and control the flow of liquid through the first spray nozzle such that a selected quantity of liquid is dispensed upon a substrate.

8. The liquid delivery system of claim 4 further comprising a controller configured to monitor and control the flow of liquid through the first spray nozzle such that a selected quantity of liquid is dispensed upon a substrate, wherein the controller is further configured to control the flow of air.

9. The liquid delivery system of claim 7 further comprising a second spray nozzle spaced apart from the first spray nozzle, wherein the second spray nozzle comprises a fluid control valve and a flow meter, wherein the controller is configured to monitor and control a flow of liquid through the second spray nozzle, and wherein the second spray nozzle receives liquid from the liquid supply line.

10. The liquid delivery system of claim 9, wherein the controller is configured to provide feedback and control of the first and second spray nozzles by receiving flow rate signals from each of the respective flow meters and outputting control signals to each of the respective fluid control valves.

11. The liquid delivery system of claim 9 further comprising a system fluid control valve and a system flow meter, wherein the system fluid control valve is configured to maintain a flow of the liquid supplied to the first spray nozzle and the second spray nozzle, and wherein the system flow meter is configured to monitor the flow of the liquid supplied to the first spray nozzle and the second spray nozzle.

12. The liquid delivery system of claim 11, wherein the controller is operable to monitor and maintain the flow of liquid to the first spray nozzle and the second spray nozzle.

13. The liquid delivery system of claim 1, wherein the liquid is one of a liquid lubricant, a corrosion preventative solution, and a hydrated dry film lubricant.

14. A liquid delivery system comprising:
a plurality of spray nozzles arranged with respect to each other to form an arrangement of spray nozzles, wherein each of the plurality of spray nozzles comprises a respective spray tip;
wherein each of the plurality of spray nozzles is configured to receive liquid via a common liquid supply line, and wherein each of the spray tips is configured to generate an atomized spray output when the liquid flowing through the spray nozzles exits through their respective spray tips; and
wherein each of the plurality of spray nozzles further comprises:
a respective fluid control valve and flow meter, wherein each fluid control valve is configured to control a flow rate of the liquid dispensed by the respective spray nozzle, and wherein each flow meter is configured to determine a flow rate of the liquid dispensed by the respective spray nozzle; and
a respective housing configured to retain and support the spray tip, the fluid control valve, and the flow meter of the respective spray nozzle.

15. The liquid delivery system of claim 14, wherein a first spray nozzle of the plurality of spray nozzles is configured to receive air via a common pressurized air supply line, and wherein the spray tip of the first spray nozzle is configured to generate an air atomized liquid spray output when the combined liquid and air flowing through the first spray nozzle exits through the first spray nozzle's spray tip.

16. The liquid delivery system of claim 15, wherein the first spray nozzle further comprises an air control valve configured to control the flow of air in the first spray nozzle assembly, and wherein the first spray nozzle's housing is configured to retain and support the first spray nozzle's air control valve.

17. The liquid delivery system of claim 16, wherein the air control valve is configured to turn the flow of air on and off.

18. The liquid delivery system of claim 16, wherein the air control valve is configured to vary the flow of air.

19. The liquid delivery system of claim 14 further comprising a controller configured to monitor and control the flow of liquid through each of the plurality of spray nozzles, such that a selected quantity of liquid is dispensed upon a substrate, and wherein the controller is configured to provide feedback and control of the plurality of spray nozzles by receiving flow rate signals from each of the respective flow meters and outputting control signals to each of the respective fluid control valves.

20. The liquid delivery system of claim 16 further comprising a controller configured to monitor and control the flow of liquid through each of the plurality of spray nozzles, such that a selected quantity of liquid is dispensed upon a substrate, wherein the controller is further configured to control the flow of air, and wherein the controller is configured to provide feedback and control of the plurality of spray nozzles by receiving flow rate signals from each of the respective flow meters and outputting control signals to each of the respective fluid control valves.

21. The liquid delivery system of claim 14, wherein the liquid is one of a liquid lubricant, a corrosion preventative solution, and a hydrated dry film lubricant.

22. The liquid delivery system of claim 20 further comprising a system fluid control valve and a system flow meter, wherein the system fluid control valve is configured to maintain a flow of the liquid supplied to the plurality of spray nozzles, and wherein the system flow meter is configured to monitor the flow of the liquid supplied to the plurality of spray nozzles.
